(19) United States
(12) Patent Application Publication
(10) Pub. No.: US 2006/0174114 A1
(43) Pub. Date: Aug. 3, 2006

(54) Method for exchanging contract information between negotiating parties

(76) Inventor: Steven L. Rosbury, Kissimmee, FL (US)

Correspondence Address: AKERMAN SENTERFITT, P.O. BOX 3188, WEST PALM BEACH, FL, 33402-3188, US

(21) Appl. No.: 11/041,717

(22) Filed: Jan. 24, 2005

(51) Int. Cl. H04L 9/00

(52) U.S. Cl. 713/168

(57) ABSTRACT

A method (100) for exchanging contract information (202) between negotiating parties comprises the steps of defining (102) a standard for labeling one or more elements (206) of contract information, applying (108) one or more labels (204) to one or more elements of the contract information in accordance with the standard, storing (110) in a file the one or more labels and associated elements of the contract information, providing (110) the negotiating parties accessibility to the file, modifying (114) the contract information as amended by the negotiating parties, and updating (118) in the file the elements of the contract information as modified by the parties while maintaining association between the one or more labels and the elements of the contract information.

### FIELD OF THE INVENTION

This invention relates generally to managing contract information, and more particularly to a method for exchanging contract information between negotiating parties.

### BACKGROUND OF THE INVENTION

Typically, contracts are negotiated between parties utilizing editors such as Microsoft Word™ or other conventional editors. Such editors, however, generally treat contract information as contiguous text with no intelligent meaning provided to elements or clauses of the contract. Consequently, negotiated elements in contracts cannot readily be acted upon intelligently by computer systems such as CLM (Contract Life-cycle Management) systems that manage large volumes of contracts. Although CLM systems may be used to intelligently assemble a contract based upon the user's business rules and language libraries, the intelligence, once exported to a text editor is lost, since the contract elements are not each tagged by the text editor. Changes to the text occurring in contract negotiation cannot be reliably recovered from the negotiated version of the document.

Providers of proprietary CLM systems have attempted to improve on the aforementioned problems by providing an editing tool with the CLM system. The editing tool operates as part of the CLM supplier's proprietary application and it tracks each contract element separately, thus providing the owner of the CLM system with a perfect audit trail of each contract element from version one of the document to the final document. This tool, however, is not portable to other proprietary CLM systems. Consequently, a negotiating party that requests the contract be negotiated with his proprietary CLM editor disenfranchises the other party from utilizing his or her own CLM system editor. The battle of the forms (the decision as to whose standard form contract will be used) thus leads to the battle of the CLM systems (the decision as to whose proprietary editor will be used).

Accordingly, party specific contract management applications lead to unproductive discussions at the onset of negotiations. Out of frustration, negotiating parties often resort to use conventional editors such as Microsoft Word™. When utilizing editors such as this which have no contract management intelligence, CLM system administrators must expend considerable manual effort to ascertain the changes made to the elements of negotiated contract before importing said changes to the CLM system. This manual process is extremely cumbersome and often leads to human error. This is especially true when an initial draft of a contract has undergone substantial edits including renumbering of sections, and/or merging of clauses.

The embodiments of the invention presented below overcome these disadvantages in the prior art.

### SUMMARY OF THE INVENTION

Embodiments in accordance with the invention provide a method for exchanging contract information between negotiating parties.

In a first embodiment of the present invention, a method is provided for exchanging contract information between negotiating parties. The method includes the steps of defining a standard for labeling one or more elements of contract information, applying one or more labels to one or more elements of the contract information in accordance with the standard, storing in a file the one or more labels and associated elements of the contract information, providing the negotiating parties accessibility to the file, modifying the contract information as amended by the negotiating parties, and updating in the file the elements of the contract information as modified by the parties while maintaining association between the one or more labels and the elements of the contract information.

In a second embodiment of the present invention, a computer-readable storage medium can be used for exchanging contract information between negotiating parties. The storage medium includes computer instructions for applying one or more labels to the one or more elements of the contract information in accordance with a standard for labeling elements of contract information, storing in a file the one or more labels and associated elements of the contract information, providing the negotiating parties accessibility to the file, modifying the contract information as amended by the negotiating parties, and updating in the file the elements of the contract information as modified by the negotiating parties while maintaining association between the one or more labels and the elements of the contract information.

In a third embodiment of the present invention, a method is presented for editing contract information. The method includes the steps of defining an API (Application Programming Interface) standard in the editor comprising API rules for labeling, presenting, exchanging, parsing, and editing one or more elements of contract information, applying the API rules to the elements of the contract information, storing in a file the results of the applying step, providing the negotiating parties accessibility to the file, modifying the contract information as amended by the negotiating parties, and updating in the file the elements of the contract information as modified by the parties while maintaining association between the API rules and the elements of the contract information.

In a fourth embodiment of the present invention, an editor operates in a computer-readable storage medium for exchanging contract information between negotiating parties. The storage medium includes computer instructions for applying API (Application Programming Interface) rules to one or more elements of contract information in accordance with an API standard comprising rules for labeling, presenting, exchanging, parsing, and editing one or more elements of contract information, storing in a file the results of the applying step, providing the negotiating parties accessibility to the file, modifying the contract information as amended by the negotiating parties, and updating in the file the elements of the contract information as modified by the parties while maintaining association between the API rules and the elements of the contract information.

### BRIEF DESCRIPTION OF THE DRAWINGS

FIGS. 1-3 are flow charts depicting multiple embodiments of a method for exchanging contract information between negotiating parties in accordance with the present invention;

FIGS. 4-5 are tables representing multiple embodiments for labeling elements of contract information in accordance with the present invention;

FIG. 6 is an illustration of how contract elements can be presented to negotiating parties in accordance with an embodiment of the present invention; and

FIG. 7 is a block diagram of a computing environment for exchanging contract information between negotiating parties in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

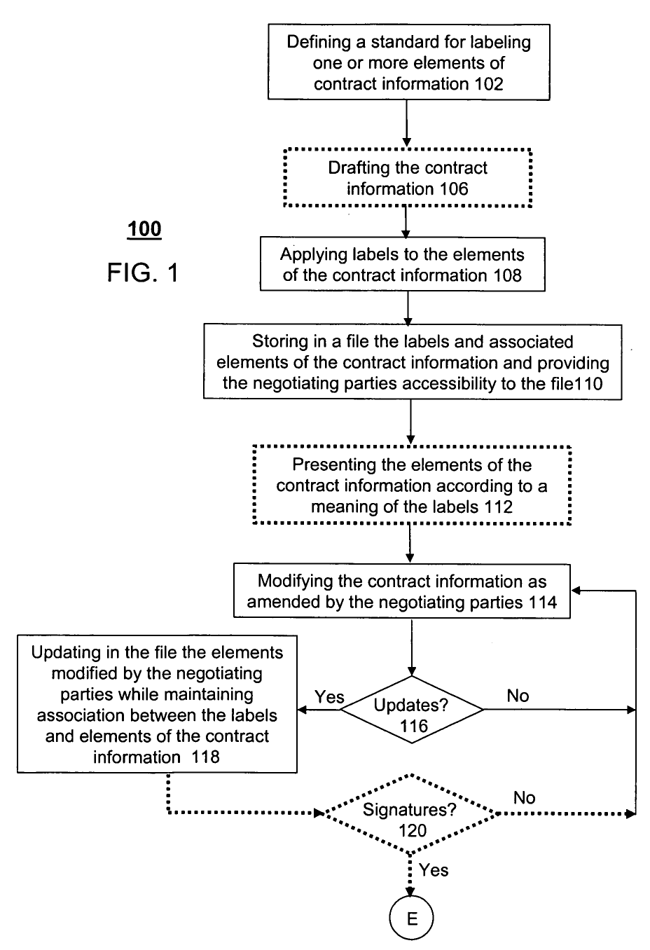

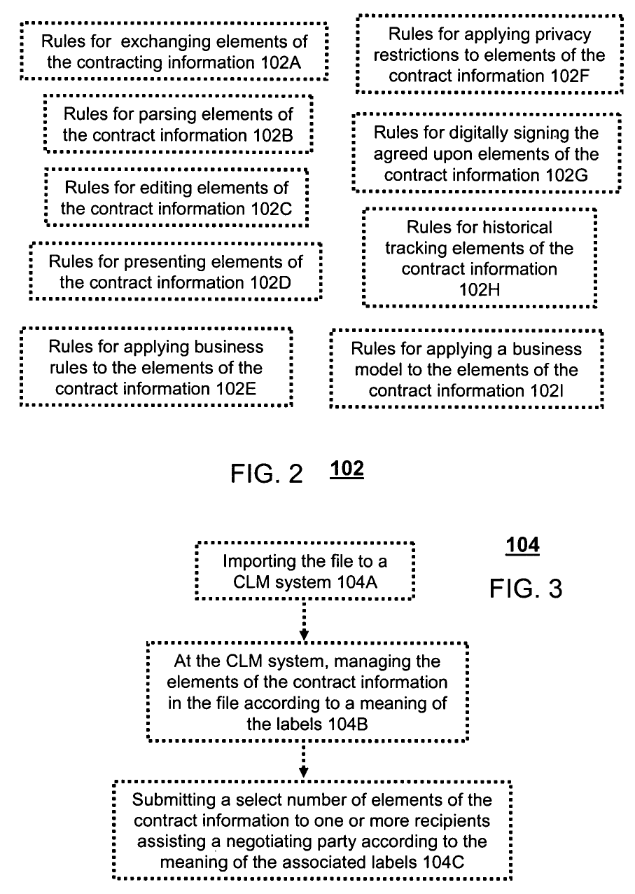

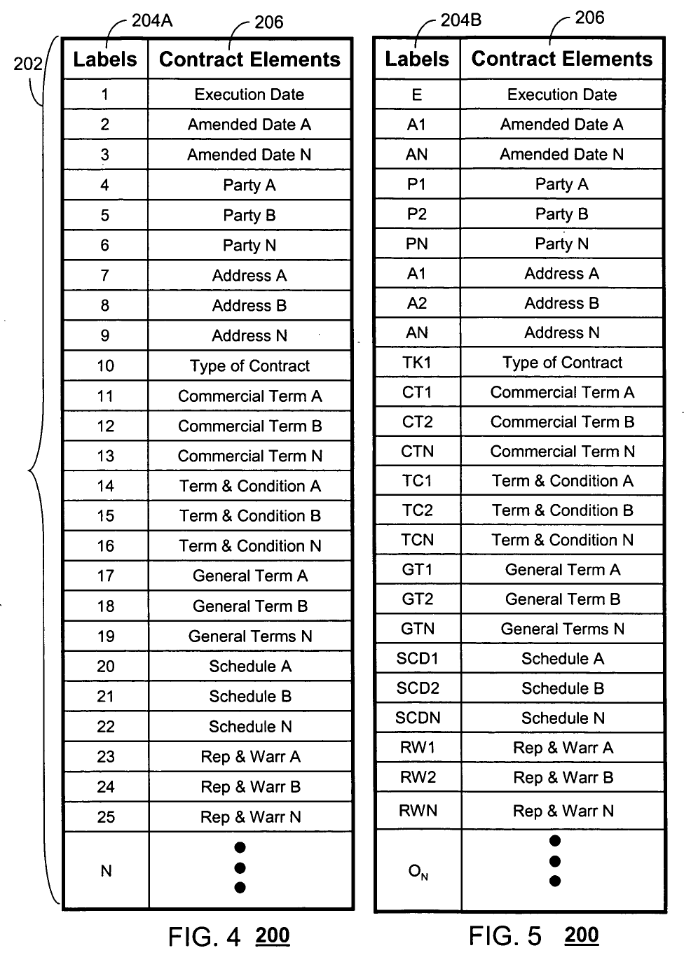

FIGS. 1-3 are flow charts depicting multiple embodiments of a method 100 for exchanging contract information between negotiating parties in accordance with the present invention. In its simplest embodiment, method 100 begins with step 102 where a standard is defined for labeling one or more elements of contract information. In step 108, labels 204 are applied to one or more elements 206 of the contract information 202 in accordance with the standard (see illustrations of FIGS. 4 and 5). In step 110, the labels 204 and associated elements 206 of the contract information 202 are stored in a conventional computer file, which is made accessible to the negotiating parties utilizing conventional means such as email or other conventional communication means over the Internet.

In step 114, the contract information 202 is modified according to amendments made by the negotiating parties. This step is generally iterative until such time the negotiating parties reach a meeting of the minds on the elements 206 of the contract information 202. Any updates made to the contract information 202 are detected in step 116, which in turn triggers step 118 for updating in the file the elements 206 of the contract information 202 as modified by the parties in step 114. During this step the association of labels 204 and negotiated elements 206 of the contract information 202 are maintained.

FIGS. 4 and 5 depict tables 200 representing multiple embodiments for labeling elements 206 of contract information 202 in accordance with the present invention. As depicted in tables 200, elements 206 of contract information 202 are represented by a segmentation of the contract information 102. In this illustration, elements 206 of contract information 102 include an execution date of the contract, amendment dates arising from a series of amendments A through N applied to the original contract, parties A through N of the contracting agreement, addresses A through N of the parties, the type of contract (e.g., purchase agreement, shareholder agreement, etc.), a series of commercial terms A through N, associated terms and conditions A through N, general terms A through N, schedules A through N, representations and warranties A through N, and other clauses A through N.

In a first embodiment, labels 204 can be represented by an enumeration scheme 204A as illustrated in FIG. 4. In an alternative embodiment, a contextual meaning 204B can be applied to each of the labels of FIG. 5 as may be applicable in describing a contracting activity. For example, the execution date can be labeled by the letter E, amended date A can be represented by the label Al, and so on. Alternatively, contextual labels can be represented by conventional metadata (i.e., data about data), or other formatting schemes. It would be obvious to an artisan with skill in the field of art of the present invention that any labeling technique applicable to the invention and within the scope and spirit of the claims described herein can be used.

Referring back to method 100, said method can be supplemented by several embodiments. For example, the standard derived from the defining step 102 can be further augmented by applying at least one among a group of rules for exchanging 102A, parsing 102B, editing 102C, presenting 102D, applying amendable business rules 102E, applying an amendable business model 102F, applying privacy restrictions 102G, digitally signing 102H, and historically tracking 102I one or more elements 206 of the contract information 202. Any one of said rules 102A-I can be applied to method 100 to further supplement the steps described therein. What follows are possible definitions that can be included in the foregoing rules.

Rules for exchanging 102A elements 206 of the contract information 202:
Defining rules for identifying recipients who can access elements 206 of the contract information
Defining rules for the parties to define custom labels and share said labels
Defining rules for the parties to mutually agree to use said custom labels
Defining rules for the parties to modify standard labels
Defining rules for the parties to mutually agree to use said modified labels

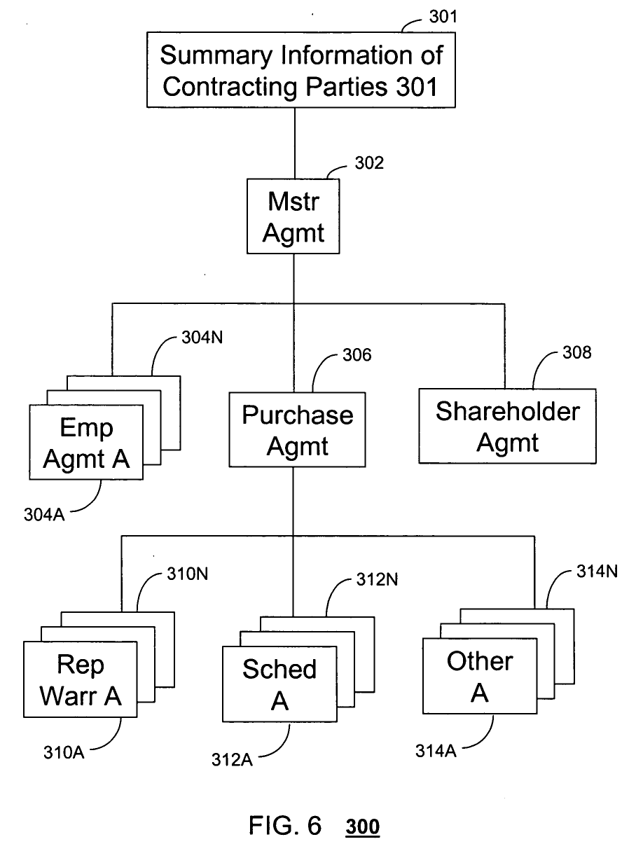

Rules for parsing 102B elements 206 of the contract information 202:
Defining rules for intelligently parsing elements 206 of contract information 202 as illustrated in FIGS. 4-5
Defining rules for parsing said elements 206 hierarchically as illustrated in FIG. 6

Rules for editing 102C elements 206 of the contract information 202:
Defining rules for restricting edits of the elements 206 of contract information 202 according to business rules set forth by, for example, a CLM system 410 and/or a negotiating party
Defining rules for time-stamping versions of edited elements 206
Defining rules for versioning edited elements 206
Defining rules for highlighting edits to the elements 206

Rules for presenting 102D elements 206 of the contract information 202:
Defining rules for presenting views of elements 206 of the contract information 202 hierarchically as shown in FIG. 6
Defining rules for presenting views of sub-elements of the hierarchy of elements 206
Defining rules for viewing formats (e.g., printable view, hierarchy view, text only view, etc.)

Rules for applying amendable business rules 102E to the elements 206 of the contract information 202:
Defining rules that a firm or individual can specify to identify parties allowed to negotiate portions of the elements 206 of the contract information 202
Defining rules that a firm or individual can specify for setting negotiable ranges of commercial terms
Defining rules that a firm or individual can specify to identify parties who must approve portions of negotiated elements 206 of the contract information 202 before the contract can be digitally signed

Rules for applying an amendable business model 102F to the elements 206 of the contract information 202:
Defining rules for associating a business model provided by a firm or individual with negotiated elements 206 of the contract information 202. The business model defined by the firm or individual can, for example, relate to the negotiating party (and/or assistants) the effects of a negotiated term on any number of business factors (e.g., the effect on gross margin at a negotiated royalty rate, the effect on manufacturing cost at negotiated purchase price, etc.)
Defining rules for presenting to the parties identified by the business rules the results of the business model according to the negotiated elements 206
Defining rules for monitoring the commercial state of negotiations according to the business model

Rules for applying privacy restrictions 102G to the elements 206 of the contract information 202:
Defining rules for restricting access to the elements 206 of the contract information 202 by parties identified by a CLM system and/or a negotiating party
Defining rules for restricting views of portions of elements 206, whereby said restrictions are applied selectively to said parties
Defining rules for password protecting elements 206 of the contract information 202

Rules for digitally signing 102H elements 206 of the contract information 202:
Defining rules for exchanging digital signatures between the negotiating parties
Defining rules for time-stamping digital signatures
Defining rules for applying an order of executing digital signatures
Defining rules for validating the authenticity of digital signatures of the negotiating parties

Rules for historically tracing 1021 elements 206 of the contract information 202:
Defining rules for tracking edits of the elements 206 by version
Defining rules for back tracing edits of a particular version
Defining rules for the type of historical information presented to a negotiating party (e.g., author of edit, time and date of edit, edit itself)
Defining rules for presenting said historical information (historical information provided in column of document view, intertwined with text of the elements 206, etc.)

The foregoing lists are but a sampling of the type of rules that can be defined for exchanging 102A, parsing 102B, editing 102C, presenting 102D, applying business rules 102E, applying a business model 102F, applying privacy restrictions 102G, digitally signing 102H, and historically tracking 102I one or more elements 206 of the contract information 202. It would be obvious to an artisan with skill in the field of art of the present invention that there are innumerable possibilities for defining the aforementioned rules (including those for labeling the elements 206). Moreover, said artisan would understand that the rules of the foregoing standard would be ever evolving, and would be amendable from time to time as circumstances change and needs arise. Accordingly, it would be clear to those skilled in the art that said evolution of the foregoing standard can be effected without departing from the spirit and scope of the invention. Lastly, the artisan can appreciate that the rules set forth above, and the elements 206 of the contract information 202 can be defined in any format suitable to the invention such as, for example, a conventional XML (eXtensible Markup Language).

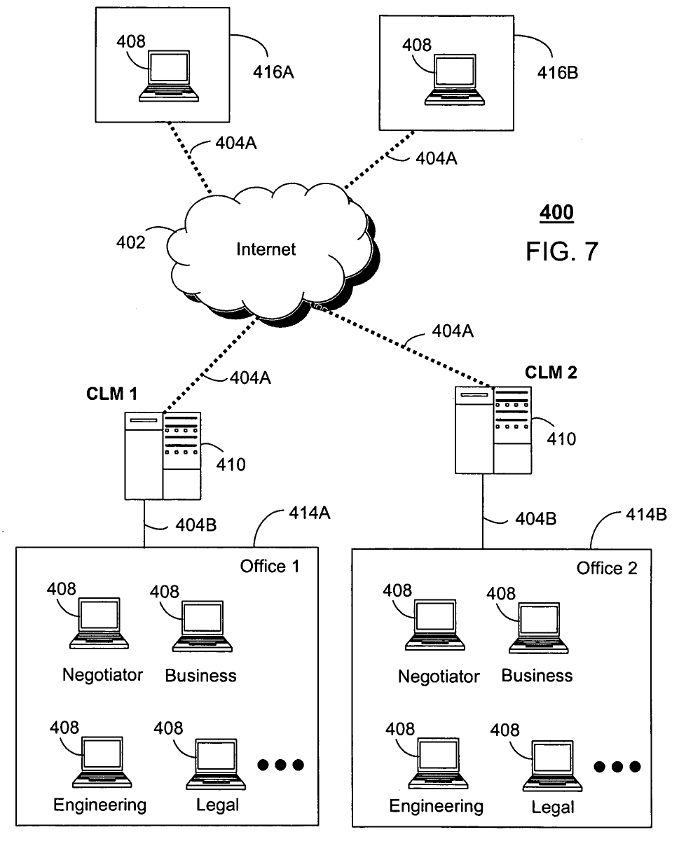

Referring again to method 100, said method can be further supplemented by the flowchart of FIG. 3. In this embodiment, the method 100 further comprises the steps of importing in step 104A the file generated in step 110 (see FIG. 1) to a conventional CLM (Contract Life-cycle Management) system 410 such as a server that conforms to the standard described above. CLM systems 410 are widely used today for the purpose of managing large volumes of contract information such as illustrated in FIGS. 4 and 5. The reader is directed to FIG. 7, which provides a block diagram 400 of a computing environment for exchanging contract information 202 between negotiating parties in accordance with an embodiment of the present invention. In this illustration, each CLM system 410 can be coupled to the Internet 402 by conventional communication means 404A (e.g., Ethernet) and offices 414 by similar conventional means for communication 404B (e.g., Intranet with Ethernet ports). Each of the offices 414A-B have a conventional computer terminal 408 (such as a desktop or laptop computer) for receiving and processing contract information 202 according to method 100.

In step 104B, the CLM system 410 manages the elements 206 of the contract information 202 in the file according to a meaning associated with the labels 204 of FIGS. 4 and 5. Said meaning can be associated with numerical labels such as 204A or contextual labels 204B. Assuming for illustration purposes that said meaning is defined by contextual labeling 204B, the CLM system 410 can utilize said labeling to identify and submit a select number of elements 206 to one or more recipients assisting a negotiating party. For example, for elements 206 having the labels CT1 through CTN (i.e., the commercial terms) the CLM system 410 can be programmed to automatically submit said elements 206 to business personnel, while elements 206 having the labels SCD1 through SCD N (i.e., schedules A through N, which for illustration are assumed to contain technical specifications for a number of products being purchased) are submitted to engineering personnel.

The recipients of each of these submissions are called on to review, approve, modify, and/or perform other relevant actions on the elements 206 of the contract information 202 according to the rules set forth in the standard and as customized by the firm or administrator of the CLM system for the specific transaction. The redistribution of these and other elements 206 of the contract information 202 to multiple reviewing parties provides a valuable and powerful means for the negotiator to effectively leverage the human and computer resources of his or her firm. The amalgamation of feedback in whole or in part from the receiving parties is then processed by the CLM system 410 and provided to the negotiating party to further the negotiations.

In yet another supplemental embodiment, the method 100 further comprises a drafting step 106. This step can be processed by a CLM system 410 and/or by a negotiating party. In the case of a CLM system 410, a boilerplate contract or a customized contract can be constructed from numerous sources within conventional databases operating in the CLM system 410. Business rules drafted by the firm in conformance with the standard may, however, dictate the use of specific contract information 202, thereby limiting customization by a negotiating party.

Alternatively, where the negotiating party does not have access to a sophisticated resource such as a CLM system 410, the negotiating party can draft or import elements 206 of contract information 202 from any source available to the negotiating party (e.g., previously stored executed or boilerplate contracts). Importing can be performed, for example, with a clipboard utilizing the copy and paste functions provided by a Windows™ environment. For any of the foregoing embodiments of step 106, business rules and/or a business model drafted by the firm or negotiating party can be associated with the chosen elements 206 of the contract information 202 so as to guide the negotiating party during the modifying step 114 of FIG. 1.

To further assist the negotiating parties, method 100 can be further enhanced by the presentation step 112 of FIG. 1. In this step, the negotiating parties can be presented with any number of presentation views of the elements 206. FIG. 6 provides an illustration in a block diagram 300 of how contract elements 206 can be presented to negotiating parties in accordance with an embodiment of the present invention. In this embodiment, the negotiating parties are provided with a hierarchical view of the elements 206 of the contract information 202 starting with summary information of the contracting parties 301, a master agreement 302, cascaded employment agreements 304A-N, a purchase agreement 306, a shareholder agreement 308, cascaded representation and warranties 310A-N, cascaded schedules 312A-312N, and other elements 314A-N of contract information 202. Depending on the business rules drafted by the negotiating parties' firm (or the negotiating party), the negotiating party may view all or portions of the underlying information represented in the block diagram 300.

From the foregoing description, it should be evident that elements 206 as referred to in the present invention can be hierarchical and can be represented by any segmentation of contract information 202 of any number of agreements. For example, an element 206 at the top level of the hierarchy can comprise a directory of agreements pertinent to a particular contracting activity. One step lower in the hierarchy, elements 206 can each be embodied in agreements. Moving further down in the hierarchy, elements 206 can be embodied in reference numbers, clauses, schedules or any other segmentation of an agreement that can prove useful in the present invention. Additionally, nesting of elements 206 can be indefinite in accordance with method 100. The accumulation of these elements 206 can be stored in one or more files in whole or in part. Thus, it would be appreciated by one of ordinary skill in the art that step 102 of method 100 for defining a standard for exchanging contract information 202 includes the foregoing embodiments with modifications and additions as may be applied thereto.

Moreover, block diagram 300 can represent more than one instance of the contract information 202 shown in FIGS. 4 and 5. That is, the illustrations of FIGS. 4 and 5 can represent one instance of an agreement (e.g., a purchase agreement), while block diagram 300 can represent multiple representations of several agreements (master agreement 302, employment agreements 304A-N, purchase agreement 206, shareholder agreement 308, etc.) and its associated elements (schedules 312A-N, representations and warranties 310A-N, etc.).

Alternatively, a negotiating party may choose a flat view, such as a table of contents or other related reference. It would be obvious to an artisan with skill in the field of art of the present invention that there are innumerable ways to present the elements 206 of contract information 202 in accordance with meanings applied to the labels 204 associated with said elements 206. It is therefore intended for said presentation variants to be inclusive of the scope and spirit of the claims described herein.

It should also be evident to the artisan that the above embodiments are not limited to the exclusive use of a CLM system 410. That is, method 100 can be embodied in a stand-alone editor that operates according to the functions described above. The editor in this embodiment incorporates an API (Application Programming Interface) standard conforming to one or more of the rules described in the aforementioned standard. Negotiating parties can use this editor to negotiate elements 206 of contract information 202 in a manner similar to method 100. Said editor can also process a single file conforming to the standard that contains a hierarchical structure of multiple contracts 202 and corresponding sub-elements 206 as shown in FIG. 6. The editor can present the negotiating parties a graphical image similar to FIG. 6, thereby providing said parties a user-friendly means for navigating through complex agreements.

Such an editor is useful to negotiating parties with or without the additional resource of a CLM system 410 such as, for example, two negotiating parties with small office resources 416A and 416B (see FIG. 7). Moreover, the availability of such an editor eliminates a contentious “battle of the forms” or “battle of the proprietary CLM systems” so long as the party offering a first draft of the contract information 202 formats the elements 206 of the contract information 202 in a manner that conforms to the rules of the standard described above. Thus, the negotiating parties can exchange contract information 202 without the disenfranchising effect of the negotiating party that makes the first move to provide a contract.

Once the negotiating parties reach a “meeting of the minds” on the negotiated elements 206 of the contract information 202, the negotiating parties are called on in a supplemental embodiment of method 100 to digitally sign the contracting document(s) in step 114 according to the rules set forth in the standard described above and customized by the negotiating parties' firms for the specific transaction. Execution of the contracting document(s) is then detected in step 120, which terminates method 100. While the contracting document(s) remain unsigned, steps 114-120 are repeated.

It should be noted that the ability to parse, export, and import portions of contract information 202 between enterprise applications complying with the foregoing method 100 and its alternative embodiments allows for automated exchange of large volumes of contract information 202. For example, a healthcare insurer can negotiate a contract with a healthcare provider utilizing the aforementioned editor so long as the contract is formatted in a file according to method 100. Upon reaching agreement said provider can import to its enterprise application from a file generated by said editor large rate tables for healthcare procedures taking place in the normal course of business of the provider. The enterprise application utilizes one or more labels 204 as described in the foregoing embodiments of method 100 to identify the contract elements 206 corresponding to the rate tables, and thereby ports said information to its databanks for processing.

The parties can renegotiate the contract information 202 frequently by utilizing the last file created by the editor as a starting point, or as amended by a CLM system 410 of the parties that conforms to method 100. As the parties renegotiate the elements 206 of the contract information 202 using said editor, the editor maintains association between the negotiated elements 206 of the contract information 202 and its corresponding labels 204. Consequently, the service provider can frequently import on its enterprise application large updated rate tables with an ease not seen before with conventional text editors like Microsoft™ Word and/or conventional CLM systems not supporting method 100. Moreover, the healthcare insurer and healthcare service provider can utilize the file(s) created above in whole or in part for negotiations with other parties, thereby improving the negotiator's ability to leverage on prior experience.

It should also be evident to the reader that in accordance with the present invention contract information 202 can comprise any form of information relevant to the negotiating parties including, but limited to, contract agreements, clauses, schedules, appendices, a profile summarizing the contracting activity, and so on. Said profile can be populated at the option of the negotiating parties. It can contain facts such as contact information of the parties (phone numbers, addresses, etc.), information pointing to related contracts, and a directory of agreements, just to name a few. The profile can be used by, for example, a CLM system and/or the negotiating parties for management purposes. Segmentation of said contract information 202 into elements 206 can be defined by the standard referred to in method 100 in any matter that proves to be suitable for effectively processing agreements between negotiating parties.

It should be evident to the reader that the present invention may be used for many applications. Thus, although the description is made for particular arrangements and methods, the intent and concept of the invention is suitable and applicable to other arrangements and applications not described herein. Accordingly, it would be clear to those skilled in the art that modifications to the disclosed embodiments can be effected without departing from the spirit and scope of the invention. The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims.

In addition, the present invention can be realized in hardware, software, or a combination of hardware and software. The present invention also can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for exchanging contract information between negotiating parties, comprising the steps of:
defining a standard for labeling one or more elements of contract information;
applying one or more labels to one or more elements of the contract information in accordance with the standard;
storing in a file the one or more labels and associated elements of the contract information;
providing the negotiating parties accessibility to the file;
modifying the contract information as amended by the negotiating parties; and
updating in the file the elements of the contract information as modified by the parties while maintaining association between the one or more labels and the elements of the contract information.

2. The method of claim 1, wherein the defining step further comprises the step of applying a contextual meaning to each of the one or more labels as applicable in describing a contracting activity.

3. The method of claim 1, wherein the modifying step further comprises the step of presenting the one or more elements of the contract information to the negotiating parties according to a meaning associated with each of the one or more labels.

4. The method of claim 1, further comprising the steps of:
applying the standard to one or more Contract Life-cycle Management (CLM) systems;
importing the file to one or more CLM systems; and
managing at each of the CLM systems the elements of the contract information in the file according to a meaning of the associated one or more labels.

5. The method of claim 4, wherein the managing step further comprises the step of submitting a select number of elements of the contract information to one or more recipients assisting a negotiating party according to the meaning of the associated one or more labels.

6. The method of claim 1, further comprising the step of drafting from a CLM system one or more among a group comprising the contract information and associated labels.

7. The method of claim 6, further comprising the steps of:
defining in the standard one or more amendable business rules that can be applied to the one or more elements of the contract information;
wherein the drafting step further comprises the step of drafting and associating one or more business rules with the elements of the contract information in accordance with the standard; and
wherein the modifying step further comprises the step of one of said negotiating parties negotiating the elements of the contract information according to the one or more business rules.

8. The method of claim 1, further comprising the steps of:
defining in the standard one or more amendable business rules that can be applied to the one or more elements of the contract information;
at least one of the negotiating parties, drafting and associating one or more business rules with the elements of the contract information in accordance with the standard; and
wherein the modifying step further comprises the step of one of said negotiating parties negotiating the elements of the contract information according to the one or more business rules.

9. The method of claim 6, further comprising the steps of:
defining in the standard an amendable business model that can be applied to the one or more elements of the contract information;
wherein the drafting step further comprises the step of drafting and associating a business model with the elements of the contract information in accordance with the standard; and
wherein the modifying step further comprises the step of one of said negotiating parties negotiating the elements of the contract information with the assistance of the business model.

10. The method of claim 1, further comprising the steps of:
defining in the standard an amendable business model that can be applied to the one or more elements of the contract information; and
at least one of the negotiating parties, drafting and associating a business model with the elements of the contract information in accordance with the standard; and
wherein the modifying step further comprises the step of one of said negotiating parties negotiating the elements of the contract information with the assistance of the business model.

11. The method of claim 1, wherein the contract information and the one or more associated labels are formatted according to an extensible markup language.

12. The method of claim 1, wherein the one or more labels can be modified by mutual consent of the negotiating parties.

13. The method of claim 1, wherein a negotiating party can specify customized labels for associating with an element of the contract information supplied by said negotiating party.

14. The method of claim 1, wherein the standard further comprises at least one among a group of rules for presenting, exchanging, parsing, editing, applying privacy restrictions, applying amendable business rules, applying an amendable business model, digitally signing, and historically tracking one or more elements of contract information; and wherein said method further comprises the step of applying at least one of said group of rules to one or more of the foregoing steps.

15. A computer-readable storage medium for exchanging contract information between negotiating parties, the storage medium comprising computer instructions for:
applying one or more labels to the one or more elements of the contract information in accordance with a standard for labeling elements of contract information;
storing in a file the one or more labels and associated elements of the contract information;
providing the negotiating parties accessibility to the file;
modifying the contract information as amended by the negotiating parties; and
updating in the file the elements of the contract information as modified by the negotiating parties while maintaining association between the one or more labels and the elements of the contract information.

16. The computer-readable storage medium of claim 15, wherein said standard applies a contextual meaning to each of the one or more labels as applicable in describing a contracting activity.

17. The computer-readable storage medium of claim 15, wherein the modifying step further comprises computer instructions for presenting the one or more elements of the contract information to the negotiating parties according to a meaning associated with each of the one or more labels.

18. The computer-readable storage medium of claim 15, further comprising computer instructions for:
importing the file to one or more Contract Life-cycle Management (CLM) systems that conform with the standard; and
managing at each of the CLM systems the elements of the contract information in the file according to a meaning of the associated one or more labels.

19. The computer-readable storage medium of claim 18, wherein the managing step further comprises computer instructions for submitting a select number of elements of the contract information to one or more recipients assisting a negotiating party according to the meaning of the associated one or more labels.

20. The computer-readable storage medium of claim 15, further comprising computer instructions for drafting from a CLM system one or more among a group comprising the contract information and associated labels.

21. The computer-readable storage medium of claim 20, wherein said standard further includes one or more amendable business rules that can be applied to the one or more elements of the contract information, and wherein the drafting step further comprises computer instructions for:
drafting and associating one or more business rules with the elements of the contract information in accordance with the standard; and
wherein the modifying step further comprises computer instructions for assisting one of said negotiating parties negotiating the elements of the contract information according to the one or more business rules.

22. The computer-readable storage medium of claim 15, wherein said standard further includes one or more amendable business rules that can be applied to the one or more elements of the contract information, and wherein said storage medium further comprises computer instructions for:
assisting at least one of the negotiating parties in drafting and associating one or more business rules with the elements of the contract information in accordance with the standard; and
wherein the modifying step further comprises computer instructions for assisting one of said negotiating parties negotiating the elements of the contract information according to the one or more business rules.

23. The computer-readable storage medium of claim 20, wherein said standard further includes an amendable business model that can be applied to the one or more elements of the contract information, and wherein the drafting step further comprises computer instructions for:
drafting and associating a business model with the elements of the contract information in accordance with the standard; and
wherein the modifying step further comprises computer instructions for assisting one of said negotiating parties negotiating the elements of the contract information according to the business model.

24. The computer-readable storage medium of claim 15, wherein said standard further includes an amendable business model that can be applied to the one or more elements of the contract information, and wherein said storage medium further comprises computer instructions for:
assisting at least one of the negotiating parties in drafting and associating a business model with the elements of the contract information in accordance with the standard; and
wherein the modifying step further comprises computer instructions for assisting one of said negotiating parties negotiating the elements of the contract information according to the business model.

25. The computer-readable storage medium of claim 15, wherein the contract information and the one or more associated labels are formatted according to an extensible markup language.

26. The computer-readable storage medium of claim 15, wherein the one or more labels can be modified by mutual consent of the negotiating parties.

27. The computer-readable storage medium of claim 15, wherein a negotiating party can specify customized labels for associating with an element of the contract information supplied by said negotiating party.

28. The computer-readable storage medium of claim 15, wherein the standard further comprises at least one among a group of rules for presenting, exchanging, parsing, editing, applying amendable business rules, applying an amendable business model, applying privacy restrictions, digitally signing, and historically tracking one or more elements of contract information; and wherein said computer-readable storage medium further comprises computer instructions for applying at least one of said group of rules to one or more of the foregoing computer instructions.

29. A method for editing contract information, comprising the steps of:
defining an API (Application Programming Interface) standard in the editor comprising API rules for labeling, presenting, exchanging, parsing, and editing one or more elements of contract information;
applying the API rules to the elements of the contract information;
storing in a file the results of the applying step;
providing the negotiating parties accessibility to the file;
modifying the contract information as amended by the negotiating parties; and
updating in the file the elements of the contract information as modified by the parties while maintaining association between the API rules and the elements of the contract information.

30. The method of claim 29, wherein the defining step further comprises the step of applying to the API rules a contextual meaning to each of the one or more labels associated with elements of the contract information as applicable in describing a contracting activity.

31. The method of claim 29, wherein the modifying step further comprises the step of presenting the one or more elements of the contract information to the negotiating parties according to a meaning associated with each of the one or more labels corresponding to elements of the contract information.

32. The method of claim 29, further comprising the steps of:
applying the API rules to one or more Contract Life-cycle Management (CLM) systems;
importing the file to one or more CLM systems; and
managing at each of the CLM systems the elements of the contract information in the file according to the API rules.

33. The method of claim 32, wherein the managing step further comprises the step of submitting a select number of elements of the contract information to one or more recipients assisting a negotiating party according to a meaning of the one or more labels associated with the elements.

34. The method of claim 29, further comprising the step of drafting from a CLM system one or more among a group comprising the contract information and labels associated with the elements of said contract information.

35. The method of claim 34, further comprising the steps of:
defining further in the API standard one or more amendable business rules that can be applied to the one or more elements of the contract information;
wherein the drafting step further comprises the step of drafting and associating one or more business rules with the elements of the contract information in accordance with the standard; and
wherein the modifying step further comprises the step of one of said negotiating parties negotiating the elements of the contract information according to the one or more business rules.

36. The method of claim 29, further comprising the steps of:
defining further in the API standard one or more amendable business rules that can be applied to the one or more elements of the contract information;
at least one of the negotiating parties, drafting and associating one or more business rules with the elements of the contract information in accordance with the standard; and
wherein the modifying step further comprises the step of one of said negotiating parties negotiating the elements of the contract information according to the one or more business rules.

37. The method of claim 34, further comprising the steps of:
defining further in the API standard an amendable business model that can be applied to the one or more elements of the contract information;
wherein the drafting step further comprises the step of drafting and associating a business model with the elements of the contract information in accordance with the standard; and
wherein the modifying step further comprises the step of one of said negotiating parties negotiating the elements of the contract information with the assistance of the business model.

38. The method of claim 29, further comprising the steps of:
defining further in the API standard an amendable business model that can be applied to the one or more elements of the contract information;
at least one of the negotiating parties, drafting and associating a business model with the elements of the contract information in accordance with the standard; and
wherein the modifying step further comprises the step of one of said negotiating parties negotiating the elements of the contract information with the assistance of the business model.

39. The method of claim 29, wherein the contract information and the one or more associated labels are formatted according to an extensible markup language.

40. The method of claim 29, wherein the one or more labels can be modified by mutual consent of the negotiating parties.

41. The method of claim 29, wherein a negotiating party can specify customized labels for associating with an element of the contract information supplied by said negotiating party.

42. The method of claim 29, wherein the API standard further comprises at least one among a group of API rules for applying amendable business rules, applying an amendable business model, applying privacy restrictions, digitally signing, and historically tracking one or more elements of contract information; and wherein said method further comprises the step of applying at least one of said group of rules to one or more of the foregoing steps.

43. An editor operating in a computer-readable storage medium for exchanging contract information between negotiating parties, the storage medium comprising computer instructions for:
applying API (Application Programming Interface) rules to one or more elements of contract information in accordance with an API standard comprising rules for labeling, presenting, exchanging, parsing, and editing one or more elements of contract information;
storing in a file the results of the applying step;
providing the negotiating parties accessibility to the file;
modifying the contract information as amended by the negotiating parties; and
updating in the file the elements of the contract information as modified by the parties while maintaining association between the API rules and the elements of the contract information.

44. The computer-readable storage medium of claim 43, wherein said API standard applies a contextual meaning to each of the one or more labels associated with elements of the contract information as applicable in describing a contracting activity.

45. The computer-readable storage medium of claim 43, wherein the modifying step further comprises computer instructions for presenting the one or more elements of the contract information to the negotiating parties according to a meaning associated with each of the one or more labels corresponding to elements of the contract information.

46. The computer-readable storage medium of claim 43, further comprising computer instructions for exporting the file to one or more enterprise applications that conform with the API standard.

47. The computer-readable storage medium of claim 43, further comprising computer instructions for importing in the file in accordance with the API standard from one or more enterprise applications one or more among a group of drafted data comprising the contract information and the labels associated with the elements of said contract information.

48. The computer-readable storage medium of claim 47, wherein said API standard further includes one or more amendable business rules that can be applied to the one or more elements of the contract information, and wherein said storage medium further comprises computer instructions for:
importing from the one or more enterprise applications one or more business rules associated the elements of the contract information in accordance with the API standard; and
wherein the modifying step further comprises computer instructions for assisting one of said negotiating parties negotiating the elements of the contract information according to the one or more business rules.

49. The computer-readable storage medium of claim 43, wherein said API standard further includes one or more amendable business rules that can be applied to the one or more elements of the contract information, and wherein said storage medium further comprises computer instructions for:
assisting at least one of the negotiating parties in drafting and associating one or more business rules with the elements of the contract information in accordance with the API standard; and
wherein the modifying step further comprises computer instructions for assisting one of said negotiating parties negotiating the elements of the contract information according to the one or more business rules.

50. The computer-readable storage medium of claim 47, wherein said API standard further includes an amendable business model that can be applied to the one or more elements of the contract information, and wherein said storage medium further comprises computer instructions for:
importing from the one or more enterprise applications a business model associated with the elements of the contract information in accordance with the API standard; and
wherein the modifying step further comprises computer instructions for assisting one of said negotiating parties negotiating the elements of the contract information according to the business model.

51. The computer-readable storage medium of claim 43, wherein said API standard further includes an amendable business model that can be applied to the one or more elements of the contract information, and wherein said storage medium further comprises computer instructions for:
assisting at least one of the negotiating parties in drafting and associating a business model with the elements of the contract information in accordance with the API standard; and
wherein the modifying step further comprises computer instructions for assisting one of said negotiating parties negotiating the elements of the contract information according to the business model.

52. The computer-readable storage medium of claim 43, wherein the contract information and the one or more associated labels are formatted according to an extensible markup language.

53. The computer-readable storage medium of claim 43, further comprising computer instructions for modifying the one or more labels by mutual consent of the negotiating parties.

54. The computer-readable storage medium of claim 43, further comprising computer instructions for assisting a negotiating party in specifying customized labels for associating with an element of the contract information.

55. The computer-readable storage medium of claim 43, wherein the API standard further comprises at least one among a group of rules for applying amendable business rules, applying an amendable business model, applying privacy restrictions, digitally signing, and historically tracking one or more elements of contract information; and wherein said storage medium further comprises computer instructions for applying at least one of said group of rules to one or more of the foregoing computer instructions.
